(19) United States
(12) Patent Application Publication
(10) Pub. No.: US 2009/0025005 A1
(43) Pub. Date: Jan. 22, 2009

(54) RESOURCE ASSIGNMENT SYSTEM

(75) Inventors: Damien R. Holzapfel, Omaha, NE (US); Marty Maness, Omaha, NE (US); Pat Watson, Fremont, NE (US)

Correspondence Address: POLSINELLI SHALTON FLANIGAN SUELTHAUS PC, 700 W. 47TH STREET, SUITE 1000, KANSAS CITY, MO, 64112-1802, US

(73) Assignee: CREIGHTON UNIVERSITY, Omaha, NE (US)

(21) Appl. No.: 11/780,586

(22) Filed: Jul. 20, 2007

(51) Int. Cl. G06F 9/46

(52) U.S. Cl. 718/104

(57) ABSTRACT

A method and system for assigning resources such as housing associated with an educational institution via communication network is disclosed. A user of a client computer sends a registration request defining registration data to a server facilitating a resource assignment service. The resource assignment service then determines the eligibility of users to use the service based on retrieved registration data, and assigns a randomly generated personal identification number (PIN) to eligible users. The resource assignment service can then assign a timeslot for eligible users to request a desired resource as a function of their assigned PINs. Users may then use the client computer to during their assigned timeslots to submit requests to the resource assignment service for desired resource assignments.

### FIELD

The present document relates to a resource assignment system, and more particularly to a resource assignment system that permits a user to access a lottery based resource assignment service over a communication network.

### BACKGROUND

With the growth of computer and information systems as well as related network technologies, such as wireless and Internet communications, ever increasing amounts of electronic information are communicated, transferred and subsequently processed by users and/or systems. As an example, computing devices, such as laptop computers, personal computers, and personal digital assistants (PDAs) are a popular means for communicating various types of electronic information. In particular, with the advent of Internet technology, such computing devices are being used more frequently to retrieve and view information available via a communication network, such as, for example, the Internet. As a result, such computing devices conveniently provide users the ability to access the Internet for the purposes of interacting with various types of web services.

Educational institutions such as colleges and universities frequently offer web based services to provide students and/or faculty access to information regarding available educational via the Internet during a registration period. As another example, web based resource assignment services allow students to apply for desired housing via the Internet. However, such conventional resource assignment services operate on a first come, first serve basis. In other words, in order to increase the likelihood of obtaining a desired housing assignment, students will attempt to access the web service as soon as the service becomes accessible. This can lead to significant loads being placed on network servers providing the resource assignment service when the service becomes accessible to students desiring to submit a housing request, which, in turn, can cause slower processing of requests, network timeouts, and possibly network failure.

### SUMMARY

In one embodiment, a method implemented by a computing device is provided for assigning a resource via a resource assignment service in response to an assignment request transferred from a client computer to a server computer via a communication network. The method can include receiving, at the server computer, a plurality of registration requests from a plurality of users of one or more the client computers, each of the plurality of registration requests including a registration data for a particular user. The method also can include identifying eligible users from the plurality of users as a function of the registration data included in each of the plurality of registration requests. Eligible users are eligible to request a resource assignment from the resource assignment service. The method can include generating a list of eligible users that includes each of the identified eligible users. The method can include assigning a random number to each eligible user in the list of eligible users. The method also includes assigning each eligible user in the list of eligible users an authorized period of time during which the eligible user can access the resource assignment service as a function of the random number assigned to that eligible user. The method can include receiving, at the server computer, an assignment request from a particular eligible user via the client. The assignment request identifies a desired resource. The method can include querying a resource database storing resource data to determine whether the desired resource is available in response to the received assignment request. The method can include assigning the desired resource to the particular eligible user when the desired resource is determined to be available.

In another embodiment, one or more computer-readable media having computer executable components executed by a computing device for assigning a resource via a resource assignment service in response to an assignment request transferred from a client computer to a server computer via a communication network. The computer-readable media can include a retrieving component for retrieving registration data for a plurality of users from a registration database. The computer-readable media can also include an identification component responsive to the retrieved registration data for identifying one or more eligible users from the plurality of users that are eligible to request a resource assignment based on the registration data retrieved from the registration database. The computer-readable media can also include an assigning component that is responsive to the identification component for assigning a random number and a unique personal identification number (PIN) to each of the identified one or more eligible users. The computer-readable media can also include a storage component responsive to the assigning component for storing the random number and the unique PIN assigned to each eligible user in the list of eligible users in a resource database. The computer-readable media can include a timeslot component that is responsive to the assigning component for assigning each of the one or more eligible users an authorized timeslot during which the eligible user can access the resource assignment service based on the random number assigned to each eligible user. The computer-readable media can also include a notification component that is responsive to the timeslot component for generating a resource assignment notification to send to each eligible user. The resource assignment notification informs each eligible user of the assigned a period of time. The computer-readable media can also include a user interface component responsive to an access request received from the client computer to transfer a graphical user interface configured for displaying resource data to the eligible user via a display of the client computer and for generating an assignment request in response to input received from the eligible user via an input device of the client computer. The input defines a desired resource. The computer-readable media can also include a determining component that is responsive to the input received from the client for querying a resource database to determine whether the desired resource is available in response to the assignment request. The computer-readable media can also include an update component that is responsive to the determining component determining that the desired resource is available to update resource data stored in the resource database to indicate that the desired resource is assigned to the eligible user.

In another embodiment, a computer readable medium having computer executable instructions is provided for assigning a resource via a resource assignment service in response to an assignment request transferred from a client computer to a server computer via a communication network. The computer readable medium includes retrieving instructions for retrieving registration data for a plurality of users from a registration database. The computer readable medium also includes identifying instructions for identifying eligible users from the plurality of users that are eligible to request a resource assignment from the resource assignment service as a function of the retrieved registration data. The computer readable medium also includes generating instructions for generating a list of eligible users that includes each of the identified eligible. The computer readable medium also includes first assigning instructions for assigning a random number to each eligible user in the list of eligible users. The computer readable medium also includes second assigning instructions for assigning each eligible user a period of time during which the eligible user can access the resource assignment service as a function of the random number assigned to that eligible user. The computer readable medium also includes third assigning instructions for assigning a unique personal identification number (PIN) to each eligible user in the list of eligible users. The computer readable medium also includes authenticating instructions for authenticating an assignment request received from a particular eligible user via the client computer based on a time the assignment request is received and the unique PIN assigned to the particular user. The assignment request identifying the unique PIN assigned to the particular eligible user and a desired resource. The computer readable medium also includes querying instructions for querying a resource database storing resource data to determine whether the desired resource is available when the received assignment request is authenticated. The computer readable medium also includes third assigning instructions for assigning the desired resource to the particular eligible user when the desired resource is determined to be available.

### BRIEF DESCRIPTION OF THE DRAWINGS

FIG. 1 is a simplified block diagram illustrating a suitable operating environment in which embodiments of the resource assignment system may be implemented;

FIG. 2 is a simplified block diagram illustrating components of a resource assignment application according to one embodiment of the resource assignment system;

FIG. 3 is a screen shot of a registration data entry form for defining registration data according to one embodiment of the resource assignment system;

FIGS. 4A-4D show various graphical user interfaces displayed to the client according to one embodiment of the resource assignment system;

FIG. 5 is a flow chart illustrating a method for assigning a timeslot to a user to select a desired resource via the resource assignment system; and

FIG. 6 is a flow chart illustrating a method for selecting a desired resource via a graphical user interface of the resource assignment system.

Corresponding reference characters indicate corresponding elements among the several views. The headings used in the figures should not be interpreted to limit the scope of the figures.

### DETAILED DESCRIPTION

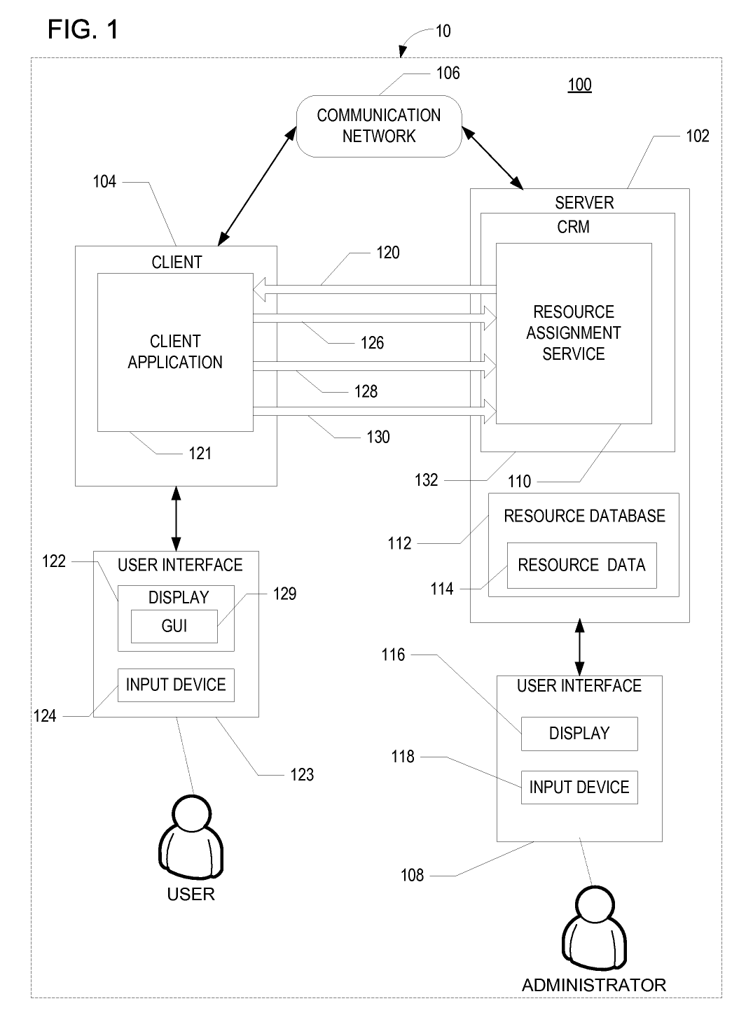

Referring to the drawings, a system and method for implementing a resource assignment system is generally indicated as 10 in FIG. 1. FIG. 1 shows a simplified block diagram illustrating various components of the resource assignment system 10 that operates in an operating environment 100 in which aspects of the resource assignment system 10 may be implemented. In this instance, FIG. 1 diagrammatically shows a cross network communication between a central server (“server”) 102 and a client computer (“client”) 104 in operating system 100. More specifically, embodiments of the resource assignment system 10 are described in the context of the server 102 being communicatively linked to the client 104 such that data can be exchanged between the server 102 and the client 104. The server 102 may be operatively coupled to the client 104 via a data communication network 106. In this example, the data communication network 106 may be the Internet (or the World Wide Web) that facilitates the transfer of resource data between the server 102 and the client 104. However, the teachings of the resource assignment system 10 can be applied to any data communication network that allows the transfer of resource data between server 102 and the client 104. In this example, the server 102 and client 104 may communicate data among themselves using a Hyper Text Transfer Protocol (HTTP) which is a protocol commonly used to facilitate communications via the Internet.

A user-interface (UI) 108 may be operatively coupled to the server 102 such that an administrator, or user, of the server 102 may interact with a resource assignment service 110 to define and/or update resource data 114 stored in a resource database 112. Resource data 114 may include the name of resources (e.g. dormitory name), the number or reservable units associated with a particular resource, and the names of persons assigned to a particular reservable unit, although other types of resource data are contemplated. For example, Table 1 shows various data fields that can be included in the resource database 112 according to an aspect of the resource assignment system 10 used in connection with a housing assignment service of an educational institution. In this example, the resource database 112 can include a building name field, a floor field, room number field, an assigned tenant 1 field, and an assigned tenant 2 field.

TABLE 1

| | | | Room | Assigned | Assigned |
|---|---|---|---|---|---|
| Record | Dormitory Name | Floor | No. | Tenant 1 | Tenant 2 |
| 1 | Kenefick | 1 | 101 | Mike Smith | John Adams |
| 2 | Kenefick | 1 | 102 | Jeff Street | |

The UI 108 may include a display 116, such as a computer monitor, for viewing resource data 112 and/or input forms, and an input device 118, such as a keyboard or a pointing device (e.g., a mouse, trackball, pen, or touch pad), for entering resource data 112 for a particular resource into an input form (not shown). For example, the administrator can use an input form to enter or to update a name of a student associated with a particular assignable unit (e.g. dormitory room) of a particular resource (e.g. dormitory).

The server 102 can execute the resource assignment service 110 to transmit a resource notification, as indicated by arrow 120, to one or more clients 104 of users eligible to request resource assignments under the resource assignment system 10. The resource notification 120 can be a predefined text or any other electronic communication message that informs a particular user that resource selection will be available during a specific period of time for that particular user under the resource assignment system 10. The resource notification 120 may include textual data and/or contextual data. Textual data includes words, numerals, punctuations etc., while contextual data may include hyperlinks, images, uniform resource locators (URLs), etc. For example, the text message may include a hyperlink or URL that corresponds to a location of the resource assignment service 110 of the particular educational institution on the Internet or other similar network and may include textual data that identifies authentication data such as a personal identification number (PIN) required for successfully submitting a resource assignment request via the resource assignment system 10.

A client application 121 may be executed on the client 104 for communicating with the server 102 in order to receive the resource notification 120 from the resource assignment service 110. The client application 121 can be, for example, an email application and/or web browsing application. After receiving the resource notification 120, the student uses a user-interface (UI) 123 operatively coupled to the client 104 to view and/or interact with the textual and contextual data. The UI 123 may include a display 122, such as a computer monitor, for viewing textual and contextual data, and an input device 124, such as a keyboard or a pointing device (e.g., a mouse, trackball, pen, or touch pad), for interacting with the textual or contextual data. For example, using navigation techniques known to those skilled in the art, the user can use the input device 124, such as a keypad, of the client 104 to select contextual data, such as the hyperlink being displayed on the display 122 of the client 104, in order to retrieve a registration form for participation in the resource assignment service 110.

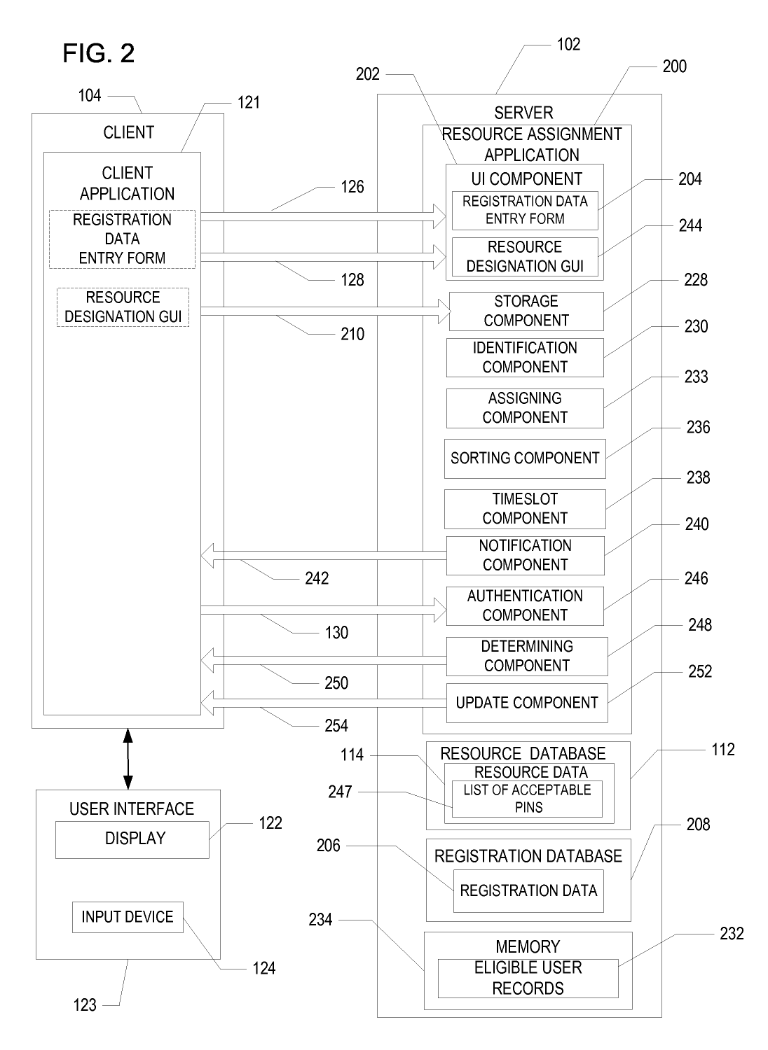

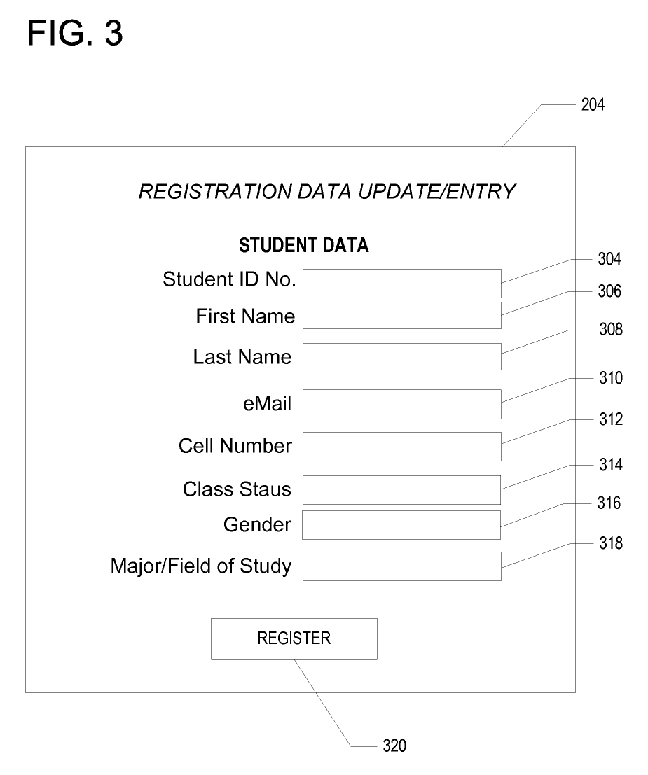

Referring to FIG. 2, the user can become eligible to use the resource assignment service 110 by completing a registration form. For example, a student user can use the input device 124 to interact with a registration form (FIG. 3) being displayed on the display 122 to enter registration data, which may include for example the first name, last name, email address, phone number, mailing address, class status (e.g., freshman, sophomore, etc.), and gender, although other types of registration data are contemplated. After the user completes the registration form, a registration request, as indicated by arrow 126, is generated by the client 104 and provided to the server 102 via the communication network 106. Notably, it is contemplated that the user can be automatically registered to access the resource assignment service 110. For example, the above registration data may be automatically retrieved from an appropriate database operatively linked to the server 102 via the communication network 106. In either case, whether or not a particular user is eligible to use the resource assignment service 110 depends on the supplied and/or automatically retrieved registration data.

After a particular user is successfully registered, the resource assignment service 110 assigns a randomly generated number (e.g., lottery number) and a personal identification number (PIN) to that particular student. Thereafter, the resource assignment service 110 is responsive to the randomly generated number to assign that particular user a period of time or timeslot during which they can use the resource assignment service 110 to enter or select one or more desired assignable units (e.g., dormitory room) of a particular resource (e.g., dormitory).

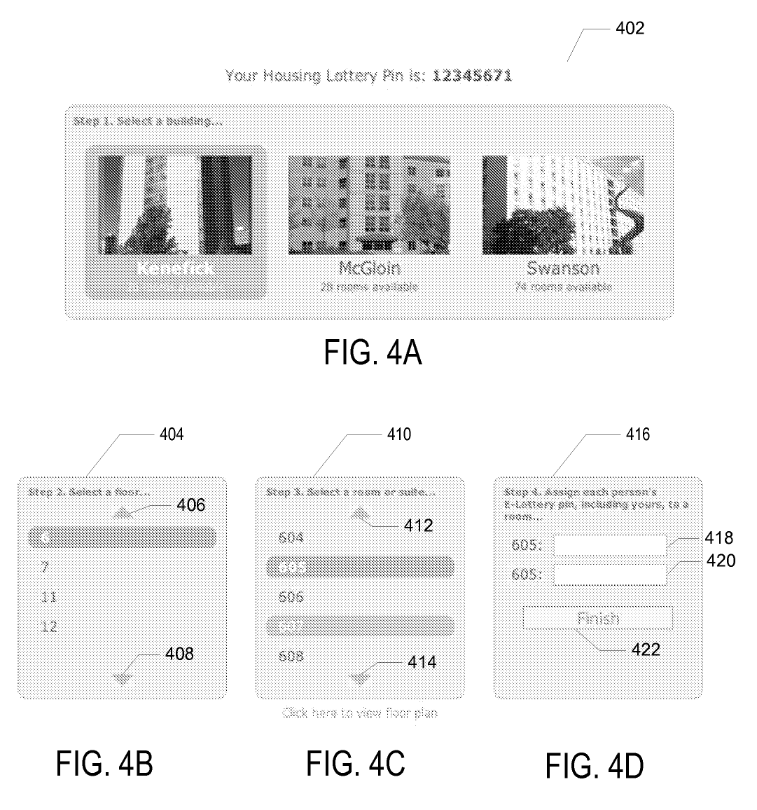

During the assigned period of time, the user can use the UI 123 of the client 104 to generate an access request, as indicated by arrow 128, to send to the server 102. The resource assignment service 110 is responsive to a received access request 128 such that resource data 114 may be retrieved from the resource database 112 and transferred to the UI 123 of the client 104 for display via a graphical user-interface 129. Thereafter, the user of the client 104 uses the input device 124 to interact with the graphical user-interface (GUI) (FIGS. 4A-4D) being shown on the display 122 of the client 104 to enter or select, for example, a desired resource. The GUI 129 is responsive to the user selecting the desired resource to generate an assignment request, as indicated by arrow 130, to request assignment for the desired resource.

As shown in FIG. 2, the resource assignment service 110 authenticates the received assignment request 130 to determine if the assignment request 130 is valid prior to processing the assignment request 130. After the assignment request 130 is authenticated, the resource assignment service 110 determines whether or not the desired resource is available. If the desired resource is available, the resource assignment service 110 can assign the desired resource to the user, update the resource database 112 to indicate that the resource has been assigned, and notify the user that desired resource has been assigned. If the desired resource is available, the resource assignment service 110 denies the assignment request 130 and can send a message to the user notifying the user the request was denied and that the user should make another resource selection.

As a result, aspects of the resource assignment system 10 provide an improved resource assignment service 110 that provides an equitable means for assigning students a period of time to access the resource assignment service 110 to register for resources such as housing associated with an educational institution via a client computer 104, while also achieving load management for the server 102 providing the resource assignment service 110. Although the resource assignment system 10 is described herein in the context of registration via a client computer, it is contemplated that the principles of the resource assignment system 10 can be applied to other computing devices 104, such as a mobile phone, personal digital assistants (PDAs), smart phones and other types of interactive wireless communication devices. Moreover, the principles of the resource assignment system 10 need not be limited to process for assigning housing being offered by an educational institution, but can be used in connection with a resource assignment process for any service or activity being offered on the Internet or similar communication network.

The operating environment 100 illustrated in FIG. 1 may include a general purpose computing device (e.g., central server 102), such as a computer executing computer-executable instructions. The computing device typically has at least some form of computer readable media (e.g., CRM 132). CRM 132, which includes both volatile and nonvolatile media, removable and non-removable media, may be any available medium that may be accessed by the general purpose computing device. By way of example and not limitation, CRM 132 may include computer storage media and communication media. CRM 132 may further include volatile and nonvolatile, removable and non-removable media implemented in any method or technology for storage of information such as computer readable instructions, data structures, program modules or other data. Communication media may typically embody computer readable instructions, data structures, program modules, or other data in a modulated data signal, such as a carrier wave or other transport mechanism and include any information delivery media. Those skilled in the art will be familiar with the modulated data signal, which may have one or more of characteristics set or changed in such a manner that permits information to be encoded in the signal. Wired media, such as a wired network or direct-wired connection, and wireless media, such as acoustic, radio frequency, infrared, and other wireless media contemplated by the resource assignment system 10, are examples of communication media discussed above. Combinations of any of the above media are also included within the scope of computer readable media discussed above.

The client 104 may include or be capable of accessing computer storage media in the form of removable and/or non-removable, volatile and/or nonvolatile memory. A user may enter commands and information into the computing device through the input device 124. Other input devices (not shown) may also be connected to the computing device. The client 104 may also operate in a networked environment using logical connections to one or more remote computers.

Although described in connection with operating environment 100, other embodiments of the resource assignment system 10 are operational with numerous other general purpose or special purpose computing system environments or configurations. The operating environment 100 is not intended to suggest any limitation as to the scope of use or functionality of the various embodiments of the resource assignment system 10. Moreover, the operating environment 100 should not be interpreted as having any dependency or requirement relating to any one or combination of components illustrated in the operating environment 100. Examples of well known operating systems, environments, and/or configurations that may be suitable for use in embodiments of the resource assignment system 10 include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Referring back to FIG. 2, a resource assignment application 200 comprising executable components can facilitate a resource assignment service 110 being offered by an educational institution for the purpose of assigning student housing. A user-interface (UI) component 202 is responsive to a registration request 126 received from the client 104 to transfer a registration data entry form 204 to the client 104 for display via the display 122. The user can use the input device 124 to interact with the registration data form 204 to define registration data 206 to store in a registration database 208 or to update registration data 206 stored in the registration database 208. Alternatively, an administrator of the server 102 can view the registration data form 204 on the display 116 (FIG. 1) operatively associated with the server 102 and use the corresponding input device 118 to interact with the registration data form 204 to define registration data 206 to store in the registration data base 208 and/or to update registration data 206 stored in the registration database 208. As described above, registration data can include the first name, last name, student number, email address, mobile phone number, mailing address, class status, financial status, and area of study. The defined registration data 206 can be used to determine whether the particular user is eligible for participation in the resource assignment service.

After the user defines registration data 206 via the registration data entry form 204 and indicates that data entry is complete by, for example, using the input device 124 to select a “register” or “OK” control button displayed on the registration data entry form 204 (FIG. 3), the client 104 then generates a storage request, as indicated by reference character 210, to store the defined registration data 206 in the registration database 208 or to update registration data 206 stored in the registration database 208. Notably, as described above, the resource assignment application 200 can be configured to automatically retrieve such registration data from a remote data source for students.

Referring to FIG. 3, registration data form 204 may be used by the user of the client 104 or by an administrator of the server 102 to define registration data 206 of one or more students. The registration data entry form 204 may include various data entry fields that each correspond to different registration data 206. In this embodiment, the various entry fields may include a student identification (ID) number field 304, a first name field 306, last name field 308, email address field 310, mobile number field 312, class status field 314, gender field 316, and an area of study field 318. The registration data entry form 204 also allows the user to indicate when data entry is complete. For example, the user may select a control button 320 labeled “Register” to indicate that the user has completed data entry.

Referring back to FIG. 2, a storage component 228 is responsive to the received storage request 210 in order to store the defined or updated registration data in the registration database 208. An identification component 230 retrieves registration data 206 from the registration database 208 to identify users that are eligible to access the resource assignment service. For example, the identification component 230 may use student name and student ID number data retrieved from the registration database 208 for a particular user to further retrieve corresponding class status information from the registration to determine if the user is in the appropriate class standing (e.g., freshman or sophomore) to use the resource assignment service. If the user has the appropriate class standing with the education institution, the user is deemed eligible for participation in the resource assignment service. For example, the identification component 230 may use student name and student ID number data retrieved from the registration database 208 for a particular user to further retrieve corresponding financial status information from a remote or local data source (not shown) to determine if the user is in good financial standing with the educational institution. If the user is in good financial standing with the education institution, the user is deemed eligible for participation in the resource assignment service. The identification component 230 further generates a list of eligible user records 232 that includes registration data 206 for each identified eligible user. The list of eligible user records 232 may be stored in a memory 234 operatively associated with the server 102.

The server 102 may further include an assigning component 233 that can assign a randomly generated number and a unique personal identification number (PIN) for each user identified in the list of eligible user records 232, and updates the corresponding eligible user record stored in the memory 234 and/or the resource database 112 to include the randomly generated number and the unique PIN. For example, as shown in Table 2 below, a first user identified in the list of eligible user records may be assigned a randomly generated number of “54321” and PIN of “00000001”, while a next user in the list of eligible user records 232 may be assigned randomly generated number of “12345” and PIN of “00000002.”

TABLE 2

| User | Randomly Assigned | |
|---|---|---|
| Record | Number | PIN |
| 1 | 54321 | 00000001 |
| 2 | 12345 | 00000002 |

A sorting component 236 can sort each of the eligible user records stored in the memory 234 according to the assigned randomly generated numbers. For example, the sorting component 236 can sort the list of eligible user records 232 stored in the memory 234 in an ascending order such that the user record having a randomly generated number of “12345” precedes the user record having a randomly generated number of “54321” (Table 3).

TABLE 3

| User | Randomly Assigned | |
|---|---|---|
| Record | Number | PIN |
| 2 | 12345 | 00000002 |
| 1 | 54321 | 00000001 |

As further shown, a timeslot component 238 can assign timeslots for each user eligible to access the resource assignment service 110 based on the sorted list of eligible user records 232. More specifically, the timeslot component 238 assigns a period of time during which eligible users can use the resource assignment service 110 in order to identify one or more resource units such as dormitory rooms in which they desire to reside. The timeslots can be configured to accommodate a predetermined number of users. For example, the first twenty-five users in the sorted list of eligible users are assigned to a timeslot beginning at 8:00 AM and ending at 8:29 AM on the date the resource assignment service 110 becomes accessible, and the next twenty-five users in the sorted list of eligible users are assigned to the next timeslot beginning at 8:30 AM and ending at 8:59 AM, and so on for the for period of time that the resource assignment service is scheduled to be available. Alternatively, the timeslot component 238 can determine an optimum number of students for each timeslot based on the total number of eligible students and the period of time that the resource assignment service 110 is scheduled to be accessible. For example, if there are 400 eligible users, and the resource assignment service 110 is scheduled to be accessible for eight hours with timeslots having a duration of 30 minutes (i.e., 16 timeslots), the timeslot component 238 determines the optimum number of students per timeslot is equal to twenty-five (i.e. 400/16). As another example, if there are 800 eligible users, and the resource assignment service 110 is scheduled to be available for eight hours with 30 minute timeslots, the timeslot component 238 determines the optimum number of students per timeslot is equal to fifty (i.e. 800/16).

According to an aspect of the resource assignment system 10, in addition to assigning timeslots as a function of the order of the eligible users in the sorted list of eligible user records, timeslots can also be determined based on retrieved registration data 206, such as gender. For example, the first twenty-five male users and the first twenty-five female users in the sorted list of eligible users are assigned to the timeslot beginning at 8:00 AM and ending at 8:29 AM on the date the resource assignment service is available, and the next twenty-five male users and the next twenty-five female users in the sorted list of eligible users are assigned to the next timeslot beginning at 8:30 AM and ending at 8:59 AM.

A notification component 240 can generate a resource assignment notification 242 that is sent to client 104 of users identified in the list of eligible user records 232. The resource assignment notification 242 can be in the form of a text or email message informing eligible users of their assigned timeslots and their unique PINs. The client application 104 is responsive to the resource assignment notification 242 received from the server 102 to allow the user to view textual and contextual data included in the resource assignment notification 242 on the display 122 of the user interface 123 operatively associated with the client 104. For example, a resource assignment notification 242 may include a hyperlink or uniform resource location (URL) address for the resource assignment service 110. The user of the client 104 can use the input device 124 of the client 104 to select the hyperlink or enter the URL address included in a resource assignment notification 242 to generate access request 128 in order to interact with one or more graphical user-interfaces provided by the UI component 202 of the resource assignment application 200.

The UI component 202 is responsive to the access request 128 received from the client 104 via the client application 121 to allow the user of the client 104 to interact with a resource designation GUI 244. More specifically, the UI component 202 is responsive to the access request 128 to transfer a main resource selection page 402 (FIG. 4A) of the resource designation GUI 244 to the client 102 for viewing on the display 122. The content displayed on the main resource selection page 402 depends, in part, on the resource data 114 stored in the resource database 112. For example, prior to transferring the resource designation GUI 244 to the client 104, the UI component 202 queries the resource database 112 to identify the types and/or names of the available resources (e.g., dormitory buildings) and number of available resource units (e.g., rooms) within each of the available resources. In the example depicted in FIG. 4A, the UI component 202 has determined that the Kenefick, McGloin, and Swanson dormitory buildings have a total of 26, 28, and 74 rooms available, respectively. According to an aspect of the resource assignment system 10, while the main resource selection page 402 is being displayed on the display 122 of the client 104, the UI component 202 automatically queries the resource database 112 on a periodic basis (e.g., 30 second intervals) to retrieve an updated number of available resource units for each available resource. The UI component 202 then replaces the number of available resource units being displayed with the updated number of available resource units. As further shown in FIG. 4A, the UI component 202 may further retrieve image data such as Joint Photographic Experts Group (jpeg) file for displaying a picture of each available resource. In this example, if the desired building still has rooms available, the user can use the input device 124 (e.g., keyboard or mouse) operatively coupled to the client 104 to select the image that corresponds to the desired building (e.g., Kenefick).

The UI component 202 is responsive to the user selecting an image that corresponds to the desired building to transfer a floor selection page 404 (FIG. 4B) of the resource designation GUI 244 to the client 102 for viewing on the display 122. The content displayed on the floor selection page 404 depends, in part, on the resource data 114 stored in the resource database 112. For example, prior to transferring the floor selection page 404 to the client 104, the UI component 202 queries the resource database 112 to identify the number of floors available in the desired building. In the example depicted in FIG. 4B, UI component 202 has determined that the desired Kenefick building at least has the sixth, seventh, eleventh, and twelfth floors available. The user can use the input device 124 (e.g., keyboard or mouse) operatively coupled to the client 104 to interact with up and down scroll arrows 406, 408, respectively, to scroll through a list of available floors numbers to display additional floors that may be available. The user can further use the input device 124 to select the floor number that corresponds to the desired floor (e.g., 6^{th} Floor).

The UI component 202 is responsive to the user selecting a floor number that corresponds to the desired floor to transfer a room selection page 410 (FIG. 4C) of the resource designation GUI 244 to the client 102 for viewing on the display 122. The content displayed on the room selection page 410 may depend, in part, on the resource data 114 stored in the resource database 112. For example, prior to transferring the room selection page 410 to the client 104, the UI component 202 queries the resource database 112 to identify the number of rooms available on the desired floor. In the example depicted in FIG. 4C, the UI component 202 has determined that the desired floor (e.g., 6^{th} Floor) in the Kenefick building at least has rooms 604, 605, 606, 607 available. The user can use the input device 124 (e.g., keyboard or mouse) operatively coupled to the client 104 to interact with up and down scroll arrows 412, 414, respectively, to scroll through the list of available room numbers. The user further uses the input device 124 to specify a desired room by selecting the room number that corresponds to the desired room (e.g., 605).

The UI component 202 is responsive to the user selecting a room number that corresponds to the desired room to transfer an enter selection page 416 (FIG. 4D) of the resource designation GUI 244 to the client 102 for viewing on the display 122. The user can use the input device 124 (e.g., keyboard or mouse) operatively coupled to the client 104 to enter the unique PIN previously supplied via the resource notification 120 into a first text box 418. If the user has a desired roommate and knows the unique PIN assigned the desired roommate, the user can use the input device 124 to enter the desired roommate's unique PIN into a second text box 420. According to one aspect of the resource assignment system 10, users can decide and coordinate outside of the system 10 to whom they give their pins, and thus authorize being the roommates of other users to whom they have provided their pins. User can provide their pins in person, via e-mail or any means of communication. The users may also identify other users as being eligible roommates (i.e. having the same class standing and gender) via other means/resources outside the scope of this system. The user of the client 104 can use the input device 124 to select a “Finish” or “Done” control button 422 to generate the assignment request 130 that identifies the desired resource data including the desired, building, floor, room, and roommate.

Referring again to FIG. 2, an authentication component 246 of the server 102 can authenticate the assignment request 130 received from the client 104 to verify that the user of the client 104 is authorized to use the resource assignment service 110. The authentication component 246 can authenticate the assignment request 130 by comparing PIN data received from the client device 104 along with the assignment request 130 to resource data 114 such as PIN data stored in the memory 234 and/or the resource database 112 on the server 102. If the PIN data received from the client 104 does not match the PIN data stored in the resource database 112 or the memory 234, the assignment request 130 is not authenticated and the user is denied further access to the resource assignment service 110. Alternatively, if the PIN data received from the client 104 matches PIN data stored in the resource database 112 or memory 234, the assignment request 130 is authenticated and the user is allowed to submit the assignment request 130 to the resource assignment service 110 for further processing.

The authentication component 246 can further authenticate the assignment request 130 by retrieving the randomly assigned number that corresponds to the PIN data received from the client 104, and then determining whether the assignment request 130 was received during a corresponding time during which the user can use the resource assignment service 110 based on the retrieved randomly assigned number. For example, as described above, the randomly generated number and the unique PIN assigned to each user by the assignment component 233 can be stored in the memory 234 and/or the resource database 112. If the assignment request 130 is received during the assigned period of time during which the user is authorized to use the resource assignment system 110, the resource assignment request 130 is authenticated and the user is allowed to submit the assignment request 130 to the resource assignment service 110 for further processing. In contrast, if the assignment request 130 is received during a period of time during which the user is not authorized to use the resource assignment system 110, the resource assignment request 130 is not authenticated and the user is denied further access to the resource assignment service 110.

The authentication component 246 can further authenticate the assignment request 130 by retrieving registration data 206 for user that corresponds to the PIN data received from the client 104 to determine the gender of the user and then retrieving resource data 114 corresponding to the desired resource to determine if the desired resource can be assigned to the user's gender. For example, if the resource data 114 indicates that a desired resource is assignable to female students, assignment request 130 from a male student will not be authenticated, and the male student will be denied assignment to the desired resource.

The authentication component 246 can further authenticate the assignment request 130 by retrieving acceptable roommate resource data 114 that corresponds to the PIN of the tenant currently assigned to the desired resource. For example, if a tenant is currently assigned to the desired resource, authentication component 246 can compare PIN data received from the client 104 to a list of acceptable PINs 247 that correspond to acceptable roommates previously defined by the current tenant and stored in the resource database 112. If PIN data received from the client 104 matches any of the PINS in the list of acceptable PINs 247, the resource assignment request 130 is authenticated and the user is allowed to submit the assignment request 130 to the resource assignment service 110 for further processing. In contrast, if PIN data received from the client 104 does not match any of the PINs in the list of acceptable PINs 247, the resource assignment request 130 is not authenticated and the user is denied assignment to the desired resource.

A determining component 248 is responsive to a validated assignment request 130 to query the resource database 112 to determine if the desired resources are available. More specifically, the determining component 248 retrieves resource data 114 from the resource database 112 that corresponds to the desired resource data identified in the assignment request 130 to determine whether the desired resource is available. For example, the determining component 248 determines whether either of the assigned tenant 1 or assigned tenant 2 fields (e.g., see Table 1) in the resource database 112 that corresponds to the desired resource (e.g., room 605 in the Kenefick) do not have an assigned tenant value. If at least one of the assigned tenant 1 or assigned tenant 2 fields does not have a value (e.g., empty), the determining component 248 determines that the desired resource is available. If both assigned tenant 1 and assigned tenant 2 fields the assigned user fields have a value, the determining component 248 determines that the desired resource is not available, and sends a unavailable notification, as indicated by arrow 250 to the client 104 to notify the user that registration was unsuccessful. According to another aspect of the resource assignment system 10, even if one of the assigned tenant 1 or assigned tenant 2 fields does not have a value (e.g., empty), the determining component 248 also determines whether the PIN of the user matches one or more acceptable roommate PINs defined by the current assigned tenant and stored in the resource database 112. If the user's PIN does not match the assigned tenants one or more acceptable roommate PINS, the determining component 248 determines that the desired resource is not available, and sends a unavailable notification, as indicated by, 250 to the client application 121 of the client 104 to notify the user that registration was unsuccessful.

An update component 252 is responsive to determining component 248 determining that the desired resource is available to update the resource data 114 that corresponds to the desired resource to indicate that the desired resource is assigned to the user. The update component 252 further sends a confirmation notification, as indicated by arrow 254, to the client application 121 of client 104 to notify the user that registration was successful.

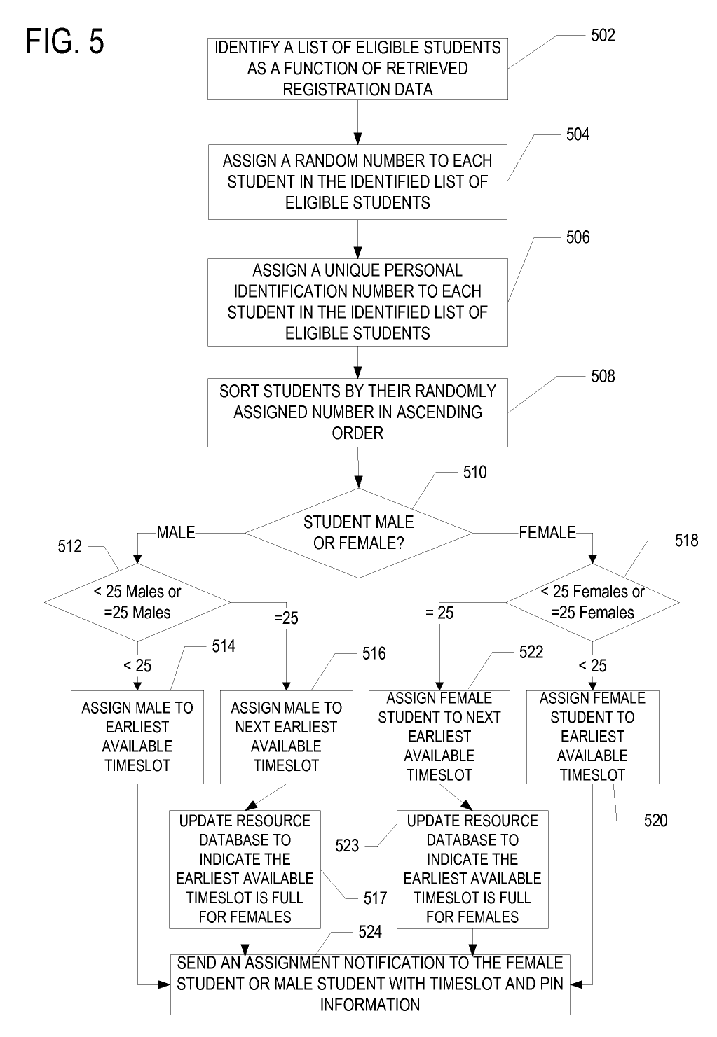

Referring to FIG. 5, method for assigning a timeslot to a user to select a desired resource via the resource assignment service 110 of an educational institution is illustrated. At 502, the resource assignment service 110 identifies a list of student users that are eligible to utilize the resource assignment system 10 based on registration data 206 retrieved from the registration database 208 that is operatively coupled to the server 102 facilitating the resource assignment service 110. The resource assignment service 110 generates and assigns a random number (e.g., lottery number) to each eligible student in the identified list of student users at 504. At 506, the resource assignment service 110 assigns a unique personal identification number (PIN) to each eligible student. The resource assignment service 110 sorts the list of eligible students such that the students identified in the list of eligible students are arranged in an ascending order based on their randomly assigned numbers at 508. At decision point 510, the resource assignment service 110 determines whether the user is male or female as a function of the retrieved registration data 206.

If the user is determined to be a male student at decision point 510, then the resource assignment service 110 determines whether there are less than twenty-five male students assigned to the earliest available timeslot at decision point 512. If there are less than twenty-five male students assigned to the earliest available timeslot, then the resource assignment service 110 assigns the male user to the earliest available timeslot at 514. If there are twenty-five male students currently assigned to the earliest available timeslot, then the resource assignment service 110 assigns the male user to the next earliest available timeslot at 516 and updates the resource database 112 to indicate the earliest available timeslot is now full for males at 517.

Alternatively, if the user is determined to be a female student at decision point 510, then the resource assignment service 110 determines whether there are less than twenty-five female students assigned to the earliest available timeslot at decision point 518. If there are less than twenty-five female students assigned to the earliest available timeslot, then the resource assignment service 110 assigns the female user to the earliest available timeslot at 520. If there are twenty-five female students currently assigned to the earliest available timeslot, then the resource assignment service 110 assigns the female user to the next earliest available timeslot at 522 and updates the resource database 112 to indicate the earliest available timeslot is now full for females at 523. In either case, the resource assignment service 110 sends an assignment notification 242 to the female student or male student at step 524. The assignment notification includes the starting time of their assigned timeslot and their unique PIN.

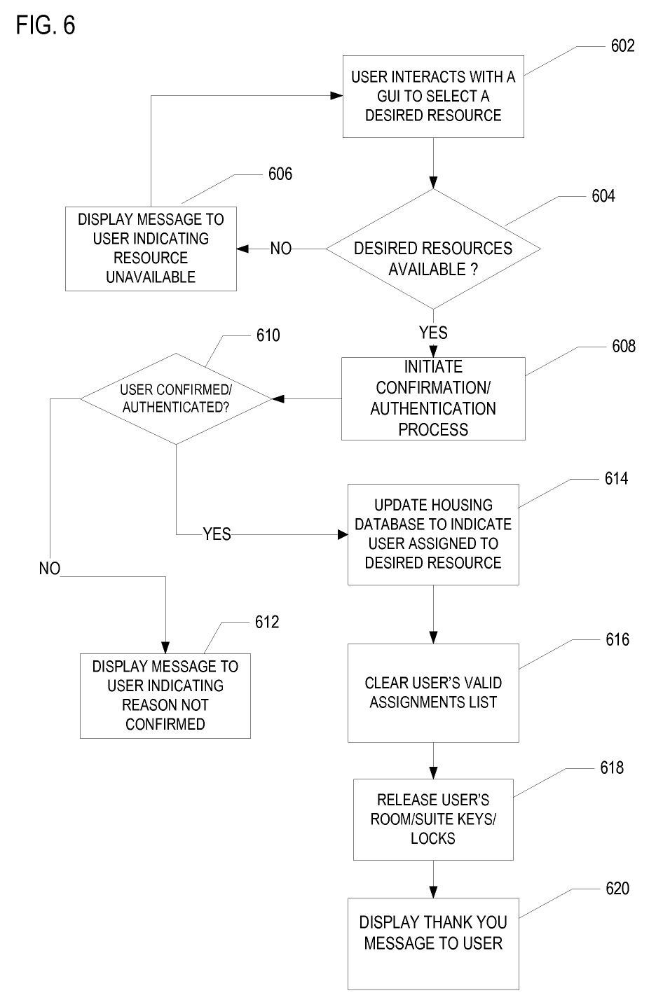

Referring to FIG. 6, a method for interacting with a graphical user interface of the resource assignment service 110 to select a desired resource of an educational institution is illustrated. At 602, the user interacts with a resource selection GUI 244 being displayed via the display 122 of the client 104 to select a desired resource. The resource assignment service 110 queries the resource database 112 to determine whether the desired resource is available at decision point 604. If the desired resource is determined not to be available at decision point 604, a resource unavailable message or page is displayed to the user via the display 122 of the client 104 at 606 and the user continues the selection process at 602. If the desired resource is determined available at decision point 604, a confirmation or authentication process is initiated at 608. As described above in reference to FIG. 2, there can be various ways to confirm or authenticate that the user is eligible to be assigned to the desired resource. For example, the resource assignment service 110 can authenticate the resource request by: determining if the user PIN supplied by the user matches valid PIN data stored in the resource database 112; determining if the user PIN supplied by the user matches valid roommate PIN data for the desired resource stored in the resource database 112; determining if the user's gender matches an assignable gender associated with the desired resource; or determining if the resource request is received during a period of time assigned to the user. At decision point 610, if the user is not authenticated or confirmed at decision point 610, the resource request is denied and a message indicating the reason for the denial is displayed to the user via the display 122 of the client 104 at 612. If the user is authenticated at decision point 610, the resource assignment service 110 updates resources data 114 in the resource database 112 to indicate that the user is assigned to the desired resource at 614. The resource assignment service 110 clears a valid assignments list at 616. A valid assignment list can be defined by entering pins the PIN entry dialog (FIG. 4D), each PIN and the corresponding room assignment are added to the valid assignments list. When the user registering those pins confirms that the assignments the user input are correct, the system performs the actual assignment of users to rooms by inserting the appropriate room assignment records into the database 122. The resource assignment service 110 releases the require locks associated with the desired resource to the user at 618. For example, keys to the door of assigned resource such as a dorm room are released to the user. At 616, the resource assignment service 110 displays a “THANK YOU” message or page to the user of the via the display 122 of the client 104.

In operation, a computer readable medium 130 executes computer-executable instructions such as those illustrated in the FIGS. 5 and 6 to implement embodiments of the resource assignment system 10.

The order of execution or performance of the operations in embodiments of the resource assignment system 10 illustrated and described herein is not essential, unless otherwise specified. That is, the operations may be performed in any order, unless otherwise specified, and embodiments of the resource assignment system 10 may include additional or fewer operations than those disclosed herein. For example, it is contemplated that executing or performing a particular operation before, contemporaneously with, or after another operation is within the scope of embodiments of the resource assignment system 10.

Embodiments of the resource assignment system 10 may be implemented with computer-executable instructions. The computer-executable instructions may be organized into one or more computer-executable components or modules. Aspects of the resource assignment system 10 may be implemented with any number and organization of such components or modules. For example, aspects of the resource assignment system 10 are not limited to the specific computer-executable instructions or the specific components or modules illustrated in the figures and described herein. Other embodiments of the resource assignment system 10 may include different computer-executable instructions or components having more or less functionality than illustrated and described herein.

When introducing elements of aspects of the resource assignment system 10 or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

As various changes could be made in the above constructions, products, and methods without departing from the scope of aspects of the invention, it is intended that all matter contained in the above description and shown in the accompanying drawings shall be interpreted as illustrative and not in a limiting sense.

What is claimed is:

1. A method implemented by a computing device for assigning a resource via a resource assignment service in response to an assignment request transferred from a client computer to a server computer via a communication network, said method comprising:
receiving, at the server computer, a plurality of registration requests from a plurality of users of one or more the client computers, each of the plurality of registration requests including a registration data for a particular user;
identifying eligible users from the plurality of users as a function of the registration data included in each of the plurality of registration requests, the eligible users being eligible to request a resource assignment from the resource assignment service;
generating a list of eligible users that includes each of the identified eligible users;
assigning a random number to each eligible user in the list of eligible users;
assigning each eligible user in the list of eligible users an authorized period of time during which the eligible user can access the resource assignment service as a function of the random number assigned to that eligible user;
receiving, at the server computer, an assignment request from a particular eligible user via the client computer, the assignment request identifying a desired resource;
querying a resource database storing resource data to determine whether the desired resource is available in response to the received assignment request; and
assigning the desired resource to the particular eligible user when the desired resource is determined to be available.

2. The method of claim 1 wherein the registration data includes first name data, last name data, email address data, phone number data, mailing address data, class status data, and gender data.

3. The method of claim 1 further comprising:
receiving, at the server computer, an access request from the particular eligible user via the client computer;
transferring a graphical user-interface to the client computer in response to the access request received from the client computer; and
generating, at the client computer, the assignment request in response to an input received from the particular eligible user via the graphical user-interface.

4. The method of claim 1 further comprising:
assigning a unique personal identification number (PIN) to each eligible user in the list of eligible users, wherein the assignment request received from the client computer further identifies the unique PIN assigned to the particular eligible user; and
authenticating the assignment request prior to assigning the desired resource to the particular eligible user based on the unique PIN identified in the assignment request, wherein authenticating the assignment request includes comparing the unique PIN identified by the assignment request to PIN data stored in the resource database or a memory;
wherein the assignment request is not authenticated and the particular user is denied the desired resource when the unique PIN does not match the PIN data stored in the resource database or the memory; and
wherein the assignment request is authenticated and the particular user is assigned the desired resource when the unique PIN matches the PIN data stored in the resource database or the memory.

5. The method of claim 4 further comprising storing the random number and the unique PIN assigned to each eligible user in the list of eligible users in the resource database or a memory, and wherein the authenticating further includes:
retrieving the random number from the resource database or the memory that corresponds to the unique PIN identified by the assignment request for the particular user; and
determining, based on the retrieved random number, whether the assignment request is received during the authorized period of time;
wherein the assignment request is not authenticated and the particular user is denied the desired resource when the assignment request is not received during the authorized period of time;
wherein the assignment request is authenticated and the particular user is assigned the desired resource when the assignment request is received during the authorized period of time.

6. The method of claim 4 wherein authenticating the assignment request further comprises:
retrieving a list of acceptable PINS from the resource database, the list of acceptable PINS including PINS of eligible users defined by another eligible user currently assigned to the desired resource;
comparing the unique PIN identified by the assignment request to the list of acceptable PINS;
wherein the assignment request is not authenticated and the user is denied the desired resource when the unique PIN does not match any of the PINS in the list of acceptable PINS; and
wherein the assignment request is authenticated and the user is assigned the desired resource when the unique PIN matches any of the PINS in the list of acceptable PINS.

7. The method of claim 1 wherein assigning each eligible user the authorized period of time further includes comparing a total number of eligible users assigned to an earliest available period of time to a predetermined threshold value, wherein the eligible user is assigned to the earliest available period of time when the total number of eligible users assigned to the earliest available period is less than the predetermined threshold value, and wherein the eligible user is assigned to a next earliest available period of time when the total number of eligible users assigned to the earliest available period is equal to the predetermined threshold value.

8. The method of claim 1 wherein resource data includes resource name data, reservable unit data, and assigned tenant data.

9. The method of claim 1 further comprising updating resource data stored in the resource database to indicate that the particular user has been assigned to the desired resource when the desired resource is determined available.

10. The method of claim 1 further comprising sending a notification to the client to notify the particular user of a status of the assignment request, wherein the notification includes a message that the desired resource has been assigned when the desired resource is available, and wherein the notification includes a message that the desired resource is unavailable when the desired resource is not available.

11. One or more computer-readable media having computer executable components executed by a computing device for assigning a resource via a resource assignment service in response to an assignment request transferred from a client computer to a server computer via a communication network, said computer-readable media comprising:
a retrieving component for retrieving registration data for a plurality of users from a registration database;
an identification component responsive to the retrieved registration data for identifying one or more eligible users from the plurality of users that are eligible to request a resource assignment based on the registration data retrieved from the registration database;
an assigning component responsive to the identification component for assigning a random number and a unique personal identification number (PIN) to each of the identified one or more eligible users;
a storage component responsive to the assigning component for storing the random number and the unique PIN assigned to each eligible user in the list of eligible users in a resource database;
a timeslot component responsive to the assigning component for assigning each of the one or more eligible users an authorized timeslot during which the eligible user can access the resource assignment service based on the random number assigned to each eligible user;
a notification component responsive to the timeslot component for generating a resource assignment notification to send to each eligible user, the resource assignment notification informing each eligible user of the authorized timeslot;
a user interface component responsive to an access request received from the client computer to transfer a graphical user interface configured for displaying resource data to the eligible user via a display of the client computer and for generating an assignment request in response to input received from the eligible user via an input device of the client computer, the input defining a desired resource;
a determining component responsive to the input received from the client for querying a resource database to determine whether the desired resource is available in response to the assignment request; and
an update component responsive to the determining component determining that the desired resource is available for updating resource data stored in the resource database to indicate that the desired resource is assigned to the eligible user.

12. The computer-readable media of claim 11 wherein the registration data includes first name data, last name data, email address data, phone number data, mailing address data, class status data, and gender data.

13. The computer-readable media of claim 11 further comprising:
an assignment component for assigning a unique personal identification number (PIN) to each eligible user in the list of eligible users, wherein the assignment request received from the client computer further identifies the unique PIN assigned to the particular eligible user; and
an authentication component for authenticating the assignment request prior to assigning the desired resource to the particular eligible user based on the unique PIN identified in the assignment request;
wherein authenticating the assignment request includes comparing the unique PIN identified by the assignment request to PIN data stored in the resource database or a memory;
wherein the assignment request is not authenticated and the user is denied the desired resource when the unique PIN does not match the PIN data stored in the resource database or the memory; and
wherein the assignment request is authenticated and the user is assigned the desired resource when the unique PIN matches the PIN data stored in the resource database or the memory.

14. The computer-readable media of claim 13 wherein the authentication component, further:
retrieves the random number from the resource database or the memory that corresponds to the unique PIN identified by the assignment request for the particular eligible user; and
determines, based on the retrieved random number, whether the assignment request is received during the authorized time slot during which the particular eligible user can access the resource assignment service;
wherein the assignment request is not authenticated and the user is denied the desired resource when the assignment request is not received during the authorized time slot; and
wherein the assignment request is authenticated and the user is assigned the desired resource when the assignment request is received during the authorized time slot.

15. The computer-readable media of claim 13 wherein the authenticating component further:
retrieves a list of acceptable PINS from the resource database, the list of acceptable PINS including PINS of eligible users defined by another eligible user currently assigned to the desired resource; and
compares the unique PIN identified by the assignment request to the list of acceptable PINS;
wherein the assignment request is not authenticated and the user is denied the desired resource when the unique PIN does not match any of the PINS in the list of acceptable PINS; and
wherein the assignment request is authenticated and the user is assigned the desired resource when the unique PIN matches match any of the PINS in the list of acceptable PINS.

16. The computer-readable media of claim 11 wherein the timeslot component assigns each eligible user the authorized timeslot by comparing a total number of eligible users assigned to an earliest available time slot to a predetermined threshold value, wherein the eligible user is assigned to the earliest time slot when the total number of eligible users assigned to the earliest available time slot is less than the predetermined threshold value, and wherein the eligible user is assigned to a next earliest available time slot when the total number of eligible users assigned to the earliest available time slot is equal to the predetermined threshold value.

17. The computer-readable media of claim 11 wherein resource data includes resource name data, reservable unit data, and assigned tenant data.

18. The computer-readable media of claim 11 further comprising and update component for updating resource data stored in the resource database to indicate that the particular user has been assigned to the desired resource when the desired resource is determined available.

19. The computer-readable media of claim 11 wherein the notification component further sends a different notification to the client to notify the particular user of a status of assignment request, wherein the different notification includes a message that the desired resource has been assigned when the desired resource is available, wherein the different notification includes a message that the desired resource is unavailable when the desired resource is not available.

20. A computer readable medium having computer executable instructions for assigning a resource via a resource assignment service in response to an assignment request transferred from a client computer to a server computer via a communication network, said computer readable medium comprising:
retrieving instructions for retrieving the registration data for a plurality of users from a registration database;
identifying instructions for identifying eligible users from the plurality of users that are eligible to request a resource assignment from the resource assignment service as a function of the retrieved registration data;
generating instructions for generating a list of eligible users that includes each of the identified eligible;
first assigning instructions for assigning a random number to each eligible user in the list of eligible users;
second assigning instructions for assigning each eligible user an authorized period of time during which the eligible user can access the resource assignment service as a function of the random number assigned to that eligible user;
third assigning instructions for assigning a unique personal identification number (PIN) to each eligible user in the list of eligible users;
authenticating instructions for authenticating an assignment request received from a particular eligible user via the client computer based on a time the assignment request is received and the unique PIN assigned to the particular user, the assignment request identifying the unique PIN assigned to the particular eligible user and a desired resource;
querying instructions for querying a resource database storing resource data to determine whether the desired resource is available when the received assignment request is authenticated; and
fourth assigning instructions for assigning the desired resource to the particular eligible user when the desired resource is determined to be available.
